(19) United States
(12) Patent Application Publication
(10) Pub. No.: US 2026/0192775 A1
(43) Pub. Date: Jul. 9, 2026

(54) INTRUDER DETECTION SYSTEM

(71) Applicant: Terri Richards, Bedias, TX (US)

(72) Inventor: Terri Richards, Bedias, TX (US)

(21) Appl. No.: 19/014,896

(22) Filed: Jan. 9, 2025

(51) Int. Cl. B60R 25/102; B60R 25/10; B60R 25/30; B60R 25/31; H04N 23/23

(52) U.S. Cl. CPC B60R 25/102; B60R 25/305; B60R 25/31; H04N 23/23; B60R 2025/1016

(57) ABSTRACT

An intruder detection system for detecting an intruder in a cabin of a vehicle includes the vehicle, which has a plurality of seats mounted in the cabin. A heat sensor is mounted in the vehicle, and processing circuitry transmits a wireless signal to a remote electronic device when the heat sensor detects a presence of a heat source within the cabin indicative of an individual positioned in the cabin. The heat sensor is mounted to an associated one of the seats of the plurality of seats of the vehicle.

### (g) BACKGROUND OF THE INVENTION

### (1) Field of the Invention

The disclosure relates to intruder detection systems and more particularly pertains to a new intruder detection system for detecting an intruder in a cabin of a vehicle.

### (2) Description of Related Art Including Information Disclosed Under 37 CFR 1.97 and 1.98

The prior art discloses various intruder detection systems for vehicles. However, the prior art fails to describe such a system that includes heat sensors embedded in the backrests of a vehicle's seats which detect heat sources in the cabin of the vehicle consistent with an intruder being positioned in the cabin. The prior art further fails to disclose such a system which transmits a signal to an alert fob device and a mobile computing device when the heat sensors detect the presence of an intruder.

### (h) BRIEF SUMMARY OF THE INVENTION

An embodiment of the disclosure meets the needs presented above by generally comprising a vehicle with a body that defines a cabin therein. The vehicle also comprises a plurality of seats which is mounted in the cabin of the body. A processor is mounted in the vehicle. A heat sensor is mounted in the vehicle and is operatively coupled to the processor. The heat sensor is configured to detect a presence of a heat source within the cabin indicative of an individual positioned in the cabin. The heat sensor is mounted to an associated one of the seats of the plurality of seats of the vehicle. A transmitter is operatively coupled to the processor. A remote electronic device is in wireless communication with the processor via the transmitter. The remote electronic device is configured to generate an intruder signal when the heat sensor detects the presence of the heat source within the cabin indicative of the individual positioned in the cabin.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of an intruder detection system according to an embodiment of the disclosure.

FIG. 2 is a top view of an embodiment of the disclosure.

FIG. 3 is a detail view of an alert fob of an embodiment of the disclosure.

FIG. 4 is a detail view of an embodiment of the disclosure which includes a cross-section of a seat of a vehicle of the embodiment.

FIG. 5 is a perspective in-use view of an embodiment of the disclosure.

FIG. 6 is a block diagram of an embodiment of the disclosure.

### (J) DETAILED DESCRIPTION OF THE INVENTION

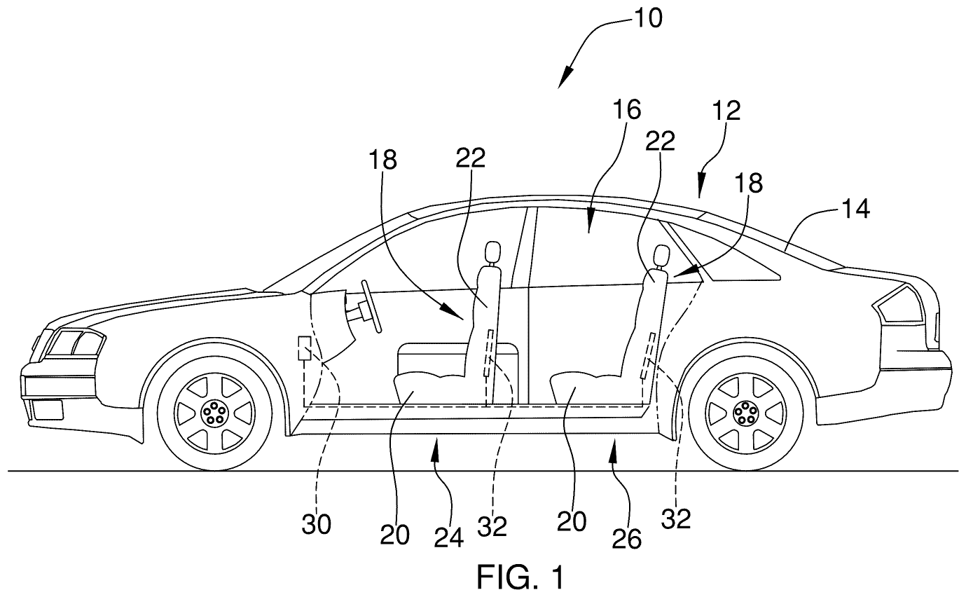

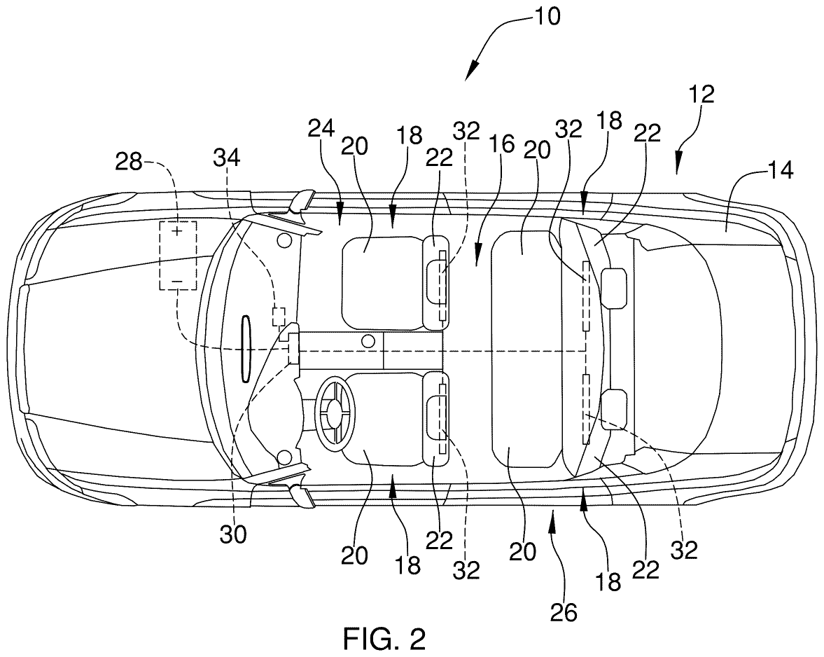

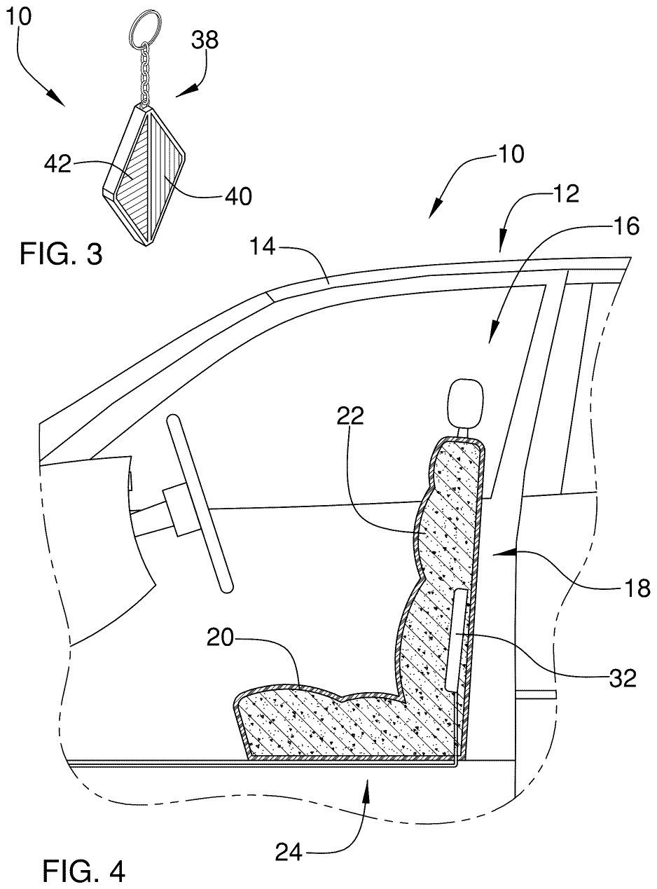

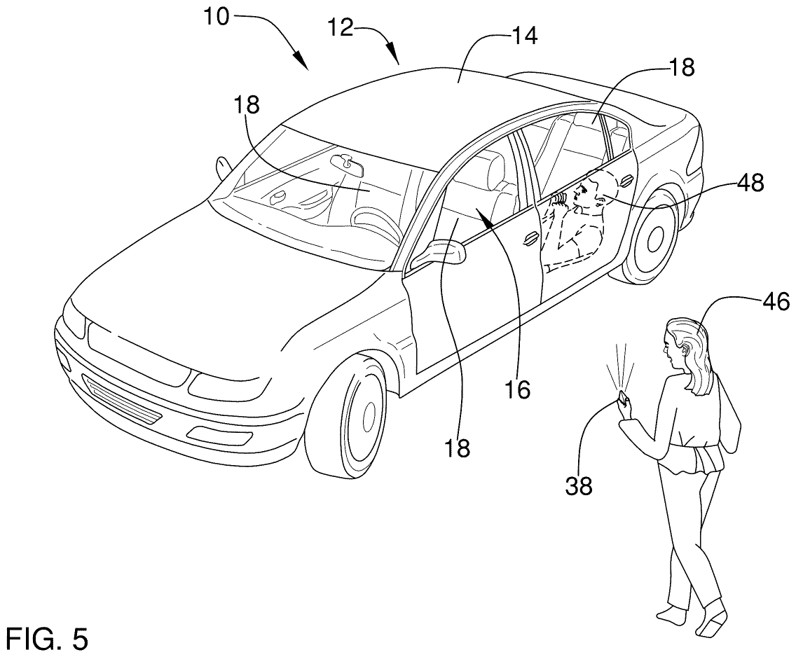

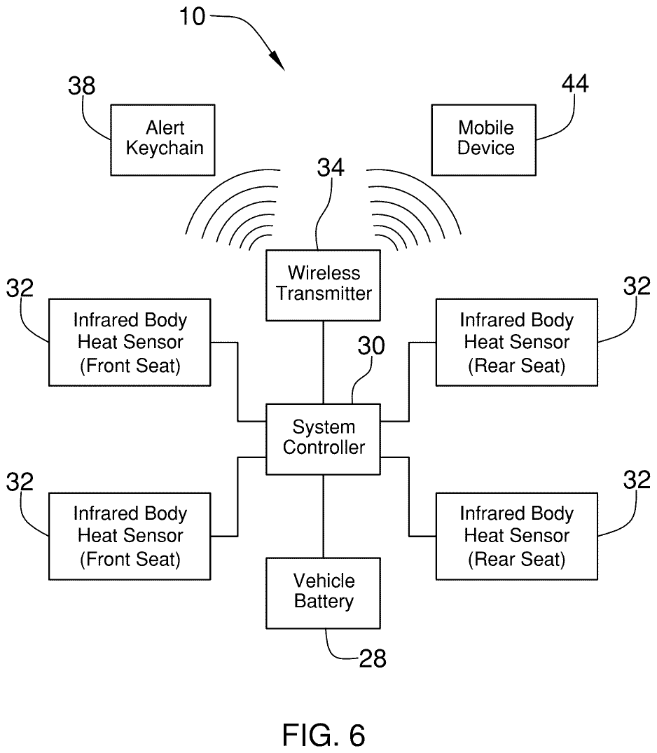

With reference now to the drawings, and in particular to FIGS. 1 through 6 thereof, a new intruder detection system embodying the principles and concepts of an embodiment of the disclosure and generally designated by the reference numeral 10 will be described.

As best illustrated in FIGS. 1 through 6, the intruder detection system 10 generally comprises a vehicle 12 which includes a body 14 that defines a cabin 16 therein. The vehicle 12 comprises a plurality of seats 18 mounted in the cabin 16 of the body 14, each of which comprises a sitting platform 20 and a backrest 22. The plurality of seats 18 is arranged in a first row 24 and a second row 26, wherein the first row 24 is positioned forwardly of the second row 26 with respect to the body 14 of the vehicle 12. The vehicle 12 comprises an electrical power source 28 which is mounted in the body 14 and which comprises a battery. The electrical power source 28 also may comprise a capacitor or other energy storage.

A processor 30 is mounted in the vehicle 12 and is electrically coupled to the electrical power source 28. A plurality of heat sensors 32 is mounted in the vehicle 12 and is operatively coupled to the processor 30. Each heat sensor 32 is configured to detect a presence of a heat source within the cabin 16 indicative of an individual positioned in the cabin 16. Each heat sensor 32 comprises an infrared radiation sensor, but other types of heat sensing technologies may be used. Each heat sensor 32 of the plurality of heat sensors 32 is embedded within the backrest 22 of an associated seat 18 of the plurality of seats 18.

A transmitter 34 is operatively coupled to the processor 30. In some embodiments, the transmitter 34 may have signal reception capabilities such that it may define a transceiver. A pair of remote electronic devices 36 is in wireless communication with the processor 30 via the transmitter 34. Each remote electronic device 36 is configured to generate an intruder signal when one of the heat sensors 32 of the plurality of heat sensors 32 detects the presence of the heat source within the cabin 16 indicative of the individual positioned in the cabin 16.

The pair of remote electronic devices 36 includes an alert fob 38 and a mobile computing device 44. The alert fob 38 comprises an intruder indication light source 40, and the intruder signal of the alert fob 38 comprises an activation of the intruder indication light source 40. The alert fob 38 further comprises a safe indication light source 42, and the alert fob 38 is configured to activate the safe indication light source 42 when the plurality of heat sensors 32 does not detect the presence of the heat source indicative of the individual positioned in the cabin 16. The intruder indication light source 40 is configured to emit red light when activated, and the safe indication light source 42 configured to emit blue light when activated. In other embodiments, the intruder indication light source 40 and the safe indication light source 42 may emit other colors of light which are different from each other, or they may be differentiated in other ways. For example, indicia such as text, graphical images, symbols, or the like may be included which identifies and differentiates the intruder indication light source 40 and the safe indication light source 42.

The pair of remote electronic devices 36 also includes a mobile computing device 44, such as a smartphone, a tablet, or the like. The mobile computing device 44 has a user interface and an application for generating the intruder signal via the user interface. For example, the intruder signal may take the form of a notification displayed on a display screen of the mobile computing device 44, an audible alert, a haptic feedback signal, or the like.

In use, the processor 30 directs each remote electronic device 36 via wireless transmission through the transmitter 34 to generate the intruder signal when at least one of the heat sensors 32 detects the presence of the heat source within the cabin 16 indicative of the individual positioned in the cabin 16. Each remote electronic device 36 generates the intruder signal in the manner described above such that a user 46 in possession of the remote electronic device 36 is able to perceive the intruder signal (e.g., by viewing the light emitted by the intruder indication light source 40 of the alert fob 38 or by hearing the audible alert from the mobile computing device 44. The user 46, upon perceiving the intruder signal, will be able to avoid entering the cabin 16 of the vehicle 12 if the user 46 determines that an intruder 48 may be present in the cabin 16. In some cases, the user 46 may determine that an intruder is unlikely to be present in the cabin 16 even when the intruder signal is generated, such as when a child, a friend, or another individual known to the user 46 is present in the cabin 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An intruder detection system comprising:
a vehicle comprising a body which defines a cabin therein, the vehicle comprising a plurality of seats mounted in the cabin of the body;
a processor mounted in the vehicle;
a heat sensor mounted in the vehicle and operatively coupled to the processor, the heat sensor being configured to detect a presence of a heat source within the cabin indicative of an individual positioned in the cabin, the heat sensor being mounted to an associated one of the seats of the plurality of seats of the vehicle;
a transmitter operatively coupled to the processor; and
a remote electronic device in wireless communication with the processor via the transmitter, the remote electronic device being configured to generate an intruder signal when the heat sensor detects the presence of the heat source within the cabin indicative of the individual positioned in the cabin.

2. The intruder detection system of claim 1, wherein:
the associated seat comprises a sitting platform and a backrest; and
the heat sensor is embedded in the backrest of the associated seat.

3. The intruder detection system of claim 1, wherein the plurality of seats is arranged in a first row and a second row, the first row being positioned forwardly of the second row with respect to the body of the vehicle, the associated seat of the heat sensor being positioned in the first row.

4. The intruder detection system of claim 1, wherein the heat sensor is one of a plurality of heat sensors mounted in the vehicle and operatively coupled to the processor, each heat sensor of the plurality of heat sensors being configured to detect the presence of the heat source within the cabin indicative of the individual positioned in the cabin, each heat sensor of the plurality of heat sensors being coupled to an associated seat of the plurality of seats.

5. The intruder detection system of claim 4, wherein:
each seat of the plurality of seats comprises a sitting platform and a backrest; and
each heat sensor of the plurality of heat sensors is embedded within the backrest of the associated seat.

6. The intruder detection system of claim 4, wherein:
the plurality of seats is arranged in a first row and a second row, the first row being positioned forwardly of the second row with respect to the body of the vehicle; and
each heat sensor of the plurality of heat sensors is coupled to a respective seat of in the first row of the plurality of seats.

7. The intruder detection system of claim 1, wherein the heat sensor comprises an infrared radiation sensor.

8. The intruder detection system of claim 1, wherein the remote electronic device comprises an alert fob, the alert fob comprising an intruder indication light source, the intruder signal of the alert fob comprising an activation of the intruder indication light source.

9. The intruder detection system of claim 8, wherein the alert fob further comprises a safe indication light source, the alert fob being configured to activate the safe indication light source when the plurality of heat sensors does not detect the presence of the heat source indicative of the individual positioned in the cabin.

10. The intruder detection system of claim 9, wherein the intruder indication light source and the safe indication light source are configured to emit light which is visually differentiable from each other.

11. The intruder detection system of claim 10, wherein the intruder indication light source is configured to emit red light when activated, the safe indication light source configured to emit blue light when activated.

12. The intruder detection system of claim 1, wherein the remote electronic device comprises a mobile computing device, the mobile computing device having a user interface, the mobile computing device having an application for generating the intruder signal via the user interface.

13. The intruder detection system of claim 1, wherein the vehicle comprises an electrical power source mounted in the body, the electrical power source comprising a battery, the processor being electrically coupled to the electrical power source.

14. An intruder detection system comprising:
a vehicle comprising a body which defines a cabin therein, the vehicle comprising a plurality of seats mounted in the cabin of the body, each seat of the plurality of seats comprising a sitting platform and a backrest, the plurality of seats being arranged in a first row and a second row, the first row being positioned forwardly of the second row with respect to the body of the vehicle, the vehicle comprising an electrical power source mounted in the body, the electrical power source comprising a battery;
a processor mounted in the vehicle, the processor being electrically coupled to the electrical power source;
a plurality of heat sensors mounted in the vehicle and operatively coupled to the processor, each heat sensor of the plurality of heat sensors being configured to detect a presence of a heat source within the cabin indicative of an individual positioned in the cabin, each heat sensor of the plurality of heat sensors comprising an infrared radiation sensor, each heat sensor of the plurality of heat sensors being embedded within the backrest of an associated seat of the plurality of seats;
a transmitter operatively coupled to the processor; and
a pair of remote electronic devices in wireless communication with the processor via the transmitter, each remote electronic device of the pair of remote electronic devices being configured to generate an intruder signal when one of the heat sensors of the plurality of heat sensors detects the presence of the heat source within the cabin indicative of the individual positioned in the cabin, each remote electronic device of the pair of remote electronic devices including:
an alert fob comprising an intruder indication light source, the intruder signal of the alert fob comprising an activation of the intruder indication light source, the alert fob further comprising a safe indication light source, the alert fob being configured to activate the safe indication light source when the plurality of heat sensors does not detect the presence of the heat source indicative of the individual positioned in the cabin, the intruder indication light source being configured to emit red light when activated, the safe indication light source configured to emit blue light when activated; and
a mobile computing device, the mobile computing device having a user interface, the mobile computing device having an application for generating the intruder signal via the user interface.
